(19) United States
(12) Patent Application Publication
(10) Pub. No.: US 2013/0284702 A1
(43) Pub. Date: Oct. 31, 2013

(54) CIRCUIT BREAKER

(71) Applicants: Yoshinobu Hamada, Kounosu-shi (JP); Yoshiyuki Kimishima, Gyoda-shi (JP); Kazunori Yonemitsu, Kounosu-shi (JP); Toshiyuki Onchi, Edogawa-ku (JP); Houjyun Yamauchi, Hachioji-shi (JP)

(72) Inventors: Yoshinobu Hamada, Kounosu-shi (JP); Yoshiyuki Kimishima, Gyoda-shi (JP); Kazunori Yonemitsu, Kounosu-shi (JP); Toshiyuki Onchi, Edogawa-ku (JP); Houjyun Yamauchi, Hachioji-shi (JP)

(73) Assignee: FUJI ELECTRIC FA COMPONENTS & SYSTEMS CO., LTD., Tokyo (JP)

(21) Appl. No.: 13/993,885

(22) PCT Filed: Feb. 8, 2012
(86) PCT No.: PCT/JP2012/000836

§ 371 Date: Jul. 9, 2013

(30) Foreign Application Priority Data
May 23, 2011 (JP) 2011-114368

(51) Int. Cl. H01H 33/18

(52) U.S. Cl. CPC H01H 33/182
USPC 218/26

(57) ABSTRACT

A circuit breaker includes a fixed contact having a fixed contact point; a movable contact having a movable contact point contacting with the fixed contact point; and an arc extinguishing device housed in a main body case. In the arc extinguishing device, a plurality of magnetic grids, each having a pair of grid leg portions, is disposed in layer form, and an arc generated between the fixed contact point and the movable contact point at a time of an opening operation is drawn into the magnetic grids and extinguished. A magnetic flux is generated between the pairs of grid leg portions configuring the arc extinguishing device in a direction perpendicular to the arc generated between the fixed contact point and the movable contact point, and permanent magnets and a permanent magnet holding member are disposed therein.

### TECHNICAL FIELD

The present invention relates to a circuit breaker, which is optimal for a high voltage direct current circuit.

### BACKGROUND ART

In order to interrupt an overcurrent in a short circuit current or overload current, flowing through a load circuit, a circuit breaker such as a wiring breaker or earth leakage breaker is used.

The circuit breaker is such that, when a movable contact carries out an operation of contacting with or separating from a fixed contact to carry out an opening and closing of a main circuit, an arc generated between a fixed contact point of the fixed contact and a movable contact point of the movable contact is extinguished in an arc extinguishing device.

The arc extinguishing device includes a plurality of grids formed in a U-shape or V-shape and a pair of side plates that supports the plurality of grids, which is disposed in a stacked condition with gaps, and is disposed so as to enclose the movement trajectory of the movable contact point. Also, by causing an electromagnetic repulsion force (Lorentz force) to be generated in a repelling direction between the fixed contact point and the movable contact point when an overcurrent flows, it is possible to cause the movable contact to move in a direction away from the fixed contact, thereby improving the breaking performance. Also, the grids of the arc extinguishing device generate an electromagnetic force that suctions the arc generated between the fixed contact point and the movable contact point.

When connecting this kind of circuit breaker to a direct current circuit, as an arc is generated when breaking the direct current circuit continues, unlike in an alternating current circuit wherein current zero comes around every constant cycle, breaking is difficult.

Therefore, a heretofore known circuit breaker connected to a direct current circuit carries out breaking by an inter-contact point gap between the fixed and movable contact points, which is increased when the contacts are opened, to increase the arc voltage, and to increase the inter-contact point voltage beyond the power source voltage of the direct current circuit, thereby attenuating the current (hereafter called a first heretofore known direct current circuit breaker).

Also, as shown in, for example, PTL 1 to 3, there is also known a device in which a permanent magnet that causes a driving force to act on an arc generated between the fixed contact point and the movable contact point so that the arc moves toward an arc extinguishing device, is mounted (hereafter called a second heretofore known direct current circuit breaker).

Furthermore, as a heretofore known circuit breaker, which is optimal for a high voltage direct current circuit, there is a device in which an arc extinguishing device wherein a plurality of grids is disposed in a stacked condition, is combined with a permanent magnet, as shown in, for example, PTL 4 and 5 (hereafter called a third heretofore known direct current circuit breaker).

### CITATION LIST

### Patent Literature

PTL 1: JP-A-11-339605

PTL 2: JP-A-10-154458

PTL 3: JP-A-10-154448

PTL 4: CN101436495A

PTL 5: CN201069749Y

### SUMMARY OF INVENTION

### Technical Problem

However, there is a concern that the first heretofore known direct current circuit breaker will become a large scale circuit breaker when the inter-contact point gap between the fixed and movable contact points is increased in order to increase the arc voltage generated between the contact points beyond the power source voltage. Conversely, if the circuit breaker is of substantially the same size as a heretofore known device used in an alternating current circuit, without increasing the inter-contact point gap between the fixed and movable contact points, there is a concern that it will not be possible to obtain sufficient breaking performance when the circuit breaker is used in a direct current circuit.

Also, there is a concern that the second and third heretofore known direct current circuit breakers will become large scale circuit breakers, as a space to dispose the arc extinguishing device, and a space to dispose the permanent magnet, are both necessary inside a main body case.

Furthermore, as the third heretofore known direct current circuit breaker is of a structure wherein the permanent magnet is disposed on the outer side of the movable contact, it has to be manufactured to distinguish a circuit breaker for an alternating current circuit from the initial assembly, and as there are few common assembly steps to a circuit breaker for an alternating current circuit, there is a problem in that productivity worsens.

Therefore, the invention has been contrived in view of the heretofore described circumstances, and has an object of providing a circuit breaker that has sufficient breaking performance in a high voltage direct current circuit, while achieving a downsizing of the device, and such that it is possible to improve productivity by the circuit breaker having the same assembly steps as an alternating current circuit breaker.

### Solution to Problem

In order to achieve the heretofore described object, a circuit breaker according to one embodiment of the invention is such that a fixed contact having a fixed contact point, a movable contact having a movable contact point that can contact with the fixed contact point, and an arc extinguishing device are housed in a main body case. The arc extinguishing device is such that a plurality of magnetic grids, each having a pair of grid leg portions extending parallel to each other from a grid base portion and being formed in a U-shape or V-shape, is disposed in layer form, and an arc generated between the fixed contact point and the movable contact point at a time of an opening operation, is drawn into the plurality of magnetic grids and extinguished, and a magnetic flux is generated between the pairs of grid leg portions of the plurality of magnetic grids configuring the arc extinguishing device in a direction perpendicular to the arc generated between the fixed contact point and the movable contact point, and permanent magnets causing an electromagnetic force to act so that the arc moves to the grid base portion side, and a permanent magnet holding member that holds the permanent magnets and encloses the movement trajectory of the movable contact point, are disposed therein.

According to the contact breaker in the one embodiment, as the electromagnetic force acts on the arc by the magnetic flux generated by the permanent magnets, the arc moves to the grid base portion side, the arc coming into contact with the magnetic grids of the arc extinguishing device is split up, cooled, and quickly extinguished, and it is thus possible to improve the breaking performance of the circuit breaker, even when it is used in a high voltage direct current circuit. Further, as the permanent magnet holding member holds the permanent magnets, and the structure is such that the permanent magnet holding member is disposed between the pairs of grid leg portions of the plurality of magnetic grids of the arc extinguishing device, it is sufficient to secure a space in the main body case to dispose the arc extinguishing device; therefore, the circuit breaker is downsized.

Also, in the circuit breaker according to the one embodiment of the invention, the permanent magnet holding member that holds the permanent magnets, can be removed from between the pairs of grid leg portions of the plurality of magnetic grids.

According to the contact breaker of the one embodiment, as it is sufficient to use the arc extinguishing device with the permanent magnet holding member installed in a direct current circuit breaker, and to use the arc extinguishing device with the permanent magnet holding member removed in an alternating current circuit breaker; in circuit breakers for an alternating current circuit and direct current circuit, both have the common assembly steps, and circuit breaker productivity improves.

Also, the circuit breaker according to the one embodiment of the invention is such that the permanent magnet holding member includes a pair of side surface insulating walls, disposed parallel to and distanced from each other, that encloses the movement trajectory of the movable contact point, and a bottom surface insulating wall that links bottom portions of the pair of side surface insulating walls, wherein the pair of side surface insulating walls holds the permanent magnets, and the bottom surface insulating wall covers the fixed contact facing the movable contact other than the fixed contact point.

According to the contact breaker of the one embodiment, it is possible to prevent an arc from being generated between a middle portion of the movable contact and the fixed contact.

Also, the circuit breaker according to the one embodiment of the invention is such that dividing walls that shield the leading end vicinity of the movable contact from the magnetic grids of the arc extinguishing device at a time of an opening operation, are provided protruding from upper portions of the pair of side surface insulating walls of the permanent magnet holding member.

According to the contact breaker of the one embodiment, an arc generated in the leading end vicinity of the movable contact is prevented from being generated on the magnetic grids by the dividing walls provided on the upper portions of the pair of side surface insulating walls of the permanent magnet holding member.

Also, the circuit breaker according to the one embodiment of the invention is such that the permanent magnet holding member is formed of a polymeric material that emits a pyrolysis gas caused by thermal decomposition.

According to the contact breaker in the one embodiment, the permanent magnet holding member emits a pyrolysis gas by thermal decomposition caused by the arc generated between the fixed contact point and movable contact point, and as the flow of the pyrolysis gas causes the arc to move in a direction to contact with the magnetic grids, it is possible to accelerate the splitting up and cooling by contact with the magnetic grids.

### Advantageous Effects of Invention

According to the contact breaker in the invention, as the electromagnetic force acts on the arc by the magnetic flux generated by the permanent magnets, the arc moves to the grid base portion side, and the arc contacting with the magnetic grids of the arc extinguishing device is split up, cooled, and quickly extinguished, and it is thus possible to improve the breaking performance of the circuit breaker, even when it is used in a high voltage direct current circuit. Also, as the permanent magnet holding member holds the permanent magnets, and the structure is such that the permanent magnet holding member is disposed between the pairs of grid leg portions of the plurality of magnetic grids of the arc extinguishing device, it is sufficient to secure a space in the main body case to dispose the arc extinguishing device; therefore, the circuit breaker can be downsized.

### BRIEF DESCRIPTION OF DRAWINGS

FIG. 1 is an exploded perspective view showing a circuit breaker according to the invention.

FIG. 2 is a main portion sectional view showing the circuit breaker according to the invention.

FIG. 3 is a perspective view showing an arc extinguishing device and a permanent magnet holding member according to the invention.

FIG. 4 is a perspective view wherein the arc extinguishing device and the permanent magnet holding member according to the invention are integrated.

FIG. 5 is a plan view showing a condition wherein a movable contact is disposed in the permanent magnet holding member according to the invention.

FIG. 6 is a diagram showing an initial condition of an arc generated between a fixed contact point and a movable contact point.

FIG. 7 is a diagram showing a permanent magnet flux and an electromagnetic force acting on the arc in the condition of FIG. 6.

FIG. 8 is a diagram showing a condition wherein the arc generated between the fixed contact point and the movable contact point moves to the arc extinguishing device side.

FIG. 9 is a diagram showing the permanent magnet flux and the electromagnetic force acting on the arc in the condition of FIG. 8.

### DESCRIPTION OF EMBODIMENTS

Hereafter, a detailed description will be given, while referring to the drawings, of an aspect (hereafter referred to as an embodiment) for implementing the invention.

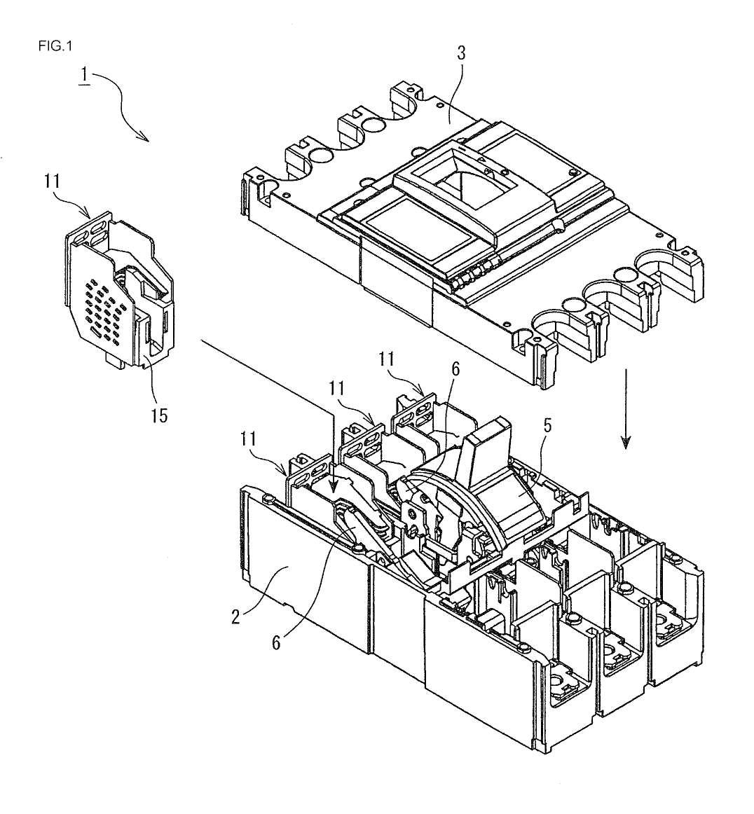

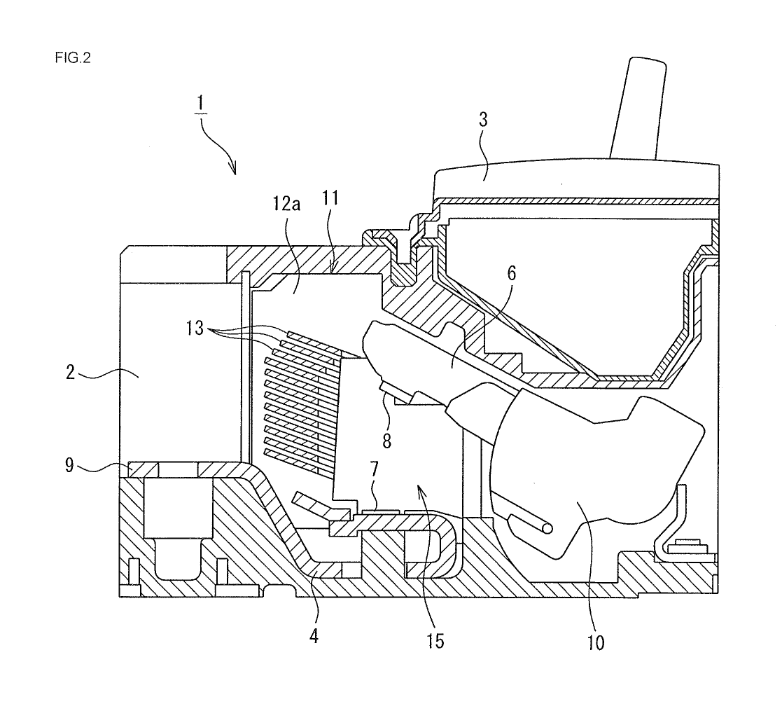

FIG. 1 is an exploded perspective view showing components of a three-pole circuit breaker (hereafter called a circuit breaker) 1 according to the invention, while FIG. 2 is a longitudinal sectional view of a main portion of the circuit breaker 1.

The circuit breaker 1 of the embodiment is such that a breaker unit formed of a fixed contact 4 fixed to a case 2 and a movable contact 6 driven so as to open and close by a switching mechanism 5 is provided inside an insulating receptacle formed of the case 2 and a cover 3, as shown in FIG. 1.

As shown in FIG. 2, the fixed contact 4 has a fixed contact point 7 at one end, while a power source side terminal 9 is integrally formed with the other end.

The movable contact 6 has a movable contact point 8 at one end, the movable contact point 8 contacting with the fixed contact point 7, while the other end is turnably linked to a movable contact holder 10 of an insulator turnably supported by the case 2, and is biased toward the fixed contact 4 by a contact spring (not shown).

As shown in FIG. 1, an arc extinguishing device 11 is disposed in the case 2 in a position enclosing the movement trajectory of the movable contact point 8 of the movable contact 6.

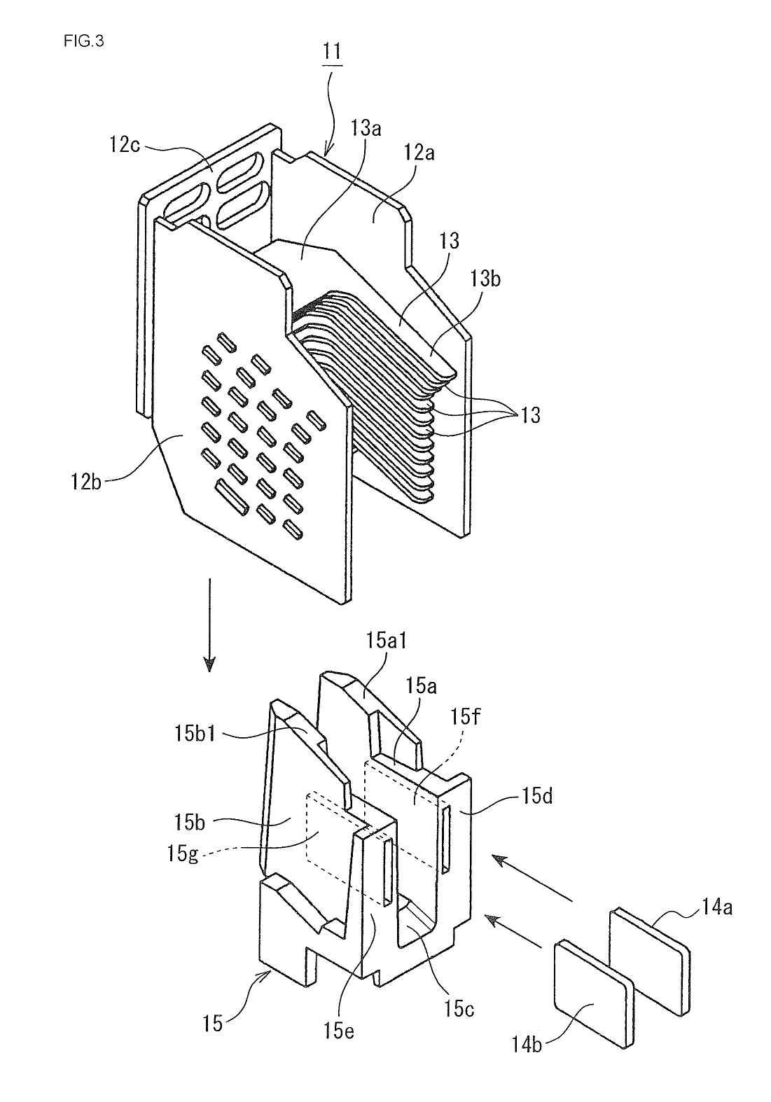

As shown in FIG. 3, the arc extinguishing device 11 is formed by a pair of side surface support plates 12a and 12b disposed parallel to each other; a plurality of grids 13, which is U-shaped or V-shaped members wherein a pair of grid leg portions 13b and 13b extends parallel to each other from a grid base portion 13a with a notched groove in one end side, fixed in a layer form between the pair of side surface support plates 12a and 12b with the pairs of grid leg portions 13b and 13b oriented in the same direction; and a back surface support plate 12c fixed between the pair of side surface support plates 12a and 12b so as to close off the plurality of grids 13 on the side not facing the pairs of grid leg portions 13b and 13b. The pair of side surface support plates 12a and 12b and the back surface support plate 12c are formed of an electrical insulating material, and the plurality of grids 13 is formed of a magnetic material. Also, a plurality of gas exhaust openings 12c1 is formed in the back surface support plate 12c, and a gas formed in the arc extinguishing device 11 is evacuated to the exterior.

As shown in FIG. 3, a pair of permanent magnets 14a and 14b, and a permanent magnet holding member 15 that holds the pair of permanent magnets 14a and 14b, are disposed between the pairs of grid leg portions 13b and 13b of the plurality of grids 13 configuring the arc extinguishing device 11.

The permanent magnet holding member 15 is formed of a polymeric material formed from a resin such as a polyamide, polyacetal, or polyester, which emits a pyrolysis gas caused by thermal decomposition, and includes a pair of side surface insulating walls 15a and 15b, parallel and opposing each other, a bottom surface insulating wall 15c linking lower portions of the pair of side surface insulating walls 15a and 15b, a pair of flange portions 15d and 15e protruding outward from lateral edge portions of the pair of side surface insulating walls 15a and 15b respectively, and a pair of permanent magnet engagement holes 15f and 15g formed in the interior of the pair of side surface insulating walls 15a and 15 and opening in the pair of flange portions 15d and 15e, as shown in FIG. 3.

The pair of permanent magnets 14a and 14b is inserted into the pair of permanent magnet engagement holes 15f and 15g, and mounted inside the pair of side surface insulating walls 15a and 15b by encapsulating with resin or an adhesive.

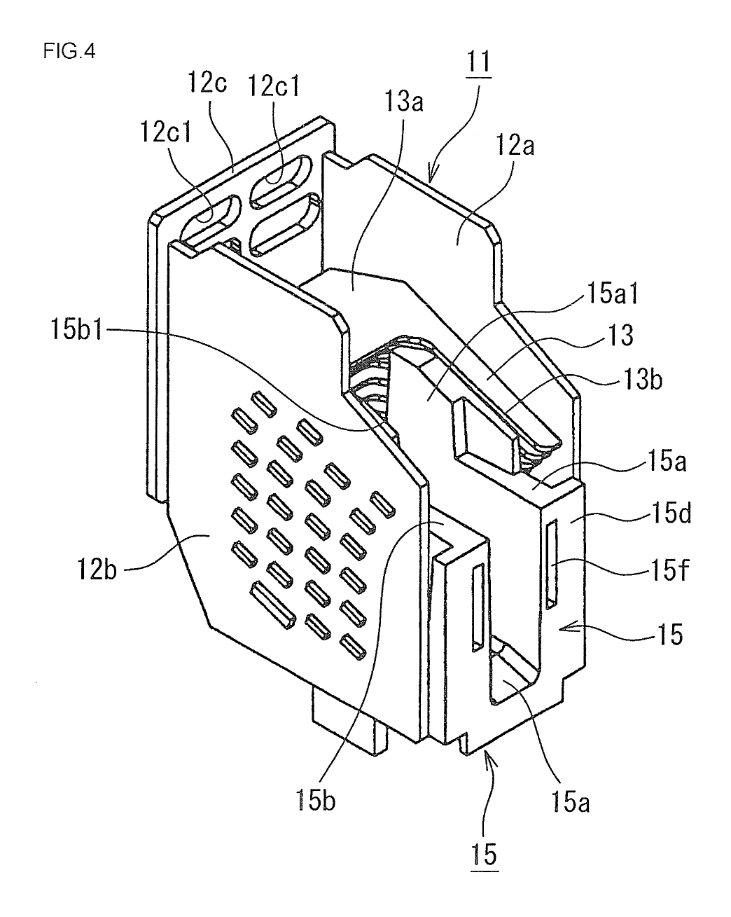

Then, the permanent magnet holding member 15 wherein the pair of permanent magnets 14a and 14b is held inside the pair of side surface insulating walls 15a and 15b, is disposed between the pairs of grid leg portions 13b and 13b of the plurality of grids 13 disposed in a layer form of the arc extinguishing device 11, as shown in FIG. 4, and the pair of side surface insulating walls 15a and 15b and bottom surface insulating wall 15c enclose the movement trajectory of the movable contact point 8 of the movable contact 6 (refer to FIG. 5).

Also, as shown in FIG. 3, dividing walls 15a1 and 15b1 that shield the leading end vicinity of the movable contact 6 in an opened position from the pairs of grid leg portions 13b and 13b of the grids 13 of the arc extinguishing device 11, are formed integrally with the pair of side surface insulating walls 15a and 15b, the dividing walls 15a1 and 15b1 protruding from the upper surfaces thereof.

Further, as shown in FIG. 1, the permanent magnet holding member 15 holds the pair of permanent magnets 14a and 14b, and the arc extinguishing device 11 wherein the permanent magnet holding member 15 is disposed between the pairs of grid leg portions 13b and 13b of the plurality of grids 13, can be mounted in a position inside the case 2 enclosing the movement trajectory of the movable contact point 8 of the movable contact 6, and can be removed from the case 2.

A main body case of the invention corresponds to the case 2, and magnetic grids of the invention correspond to the grids 13.

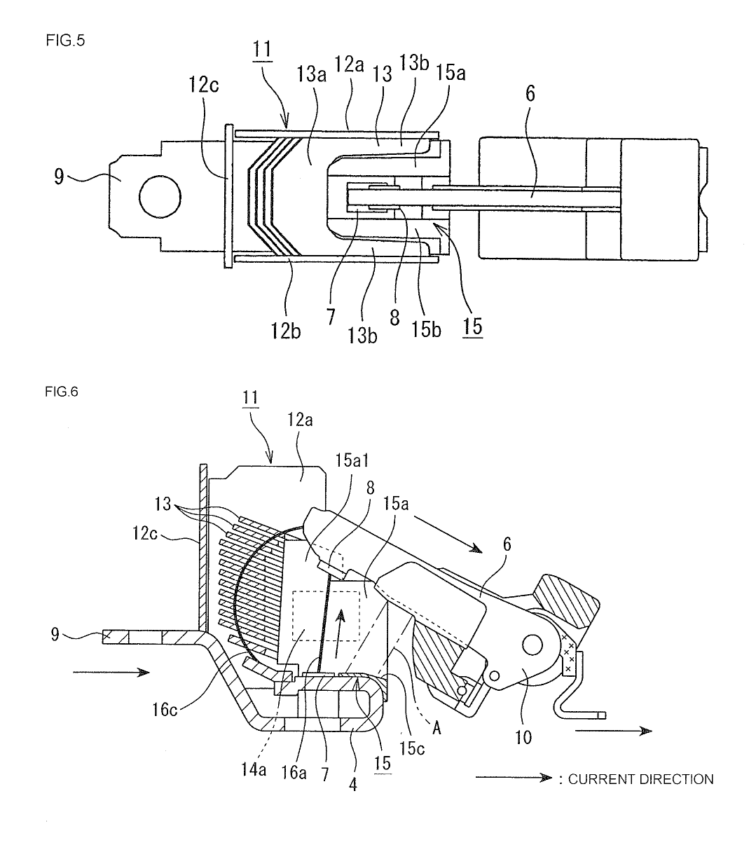

Next, a description will be given, referring to FIG. 6 to FIG. 9, of an operational advantage of the embodiment. When an overcurrent, which is a short circuit current or overload current, flows through the circuit breaker 1 with the heretofore described configuration, an electromagnetic repulsion force caused by current concentration acts between the fixed contact point 7 and the movable contact point 8, and the movable contact opens against the biasing force of the contact spring (not shown), as shown in FIG. 6. Further, simultaneously with the movable contact 6 opening, an arc 16a is generated between the fixed and the movable contact points 7 and 8.

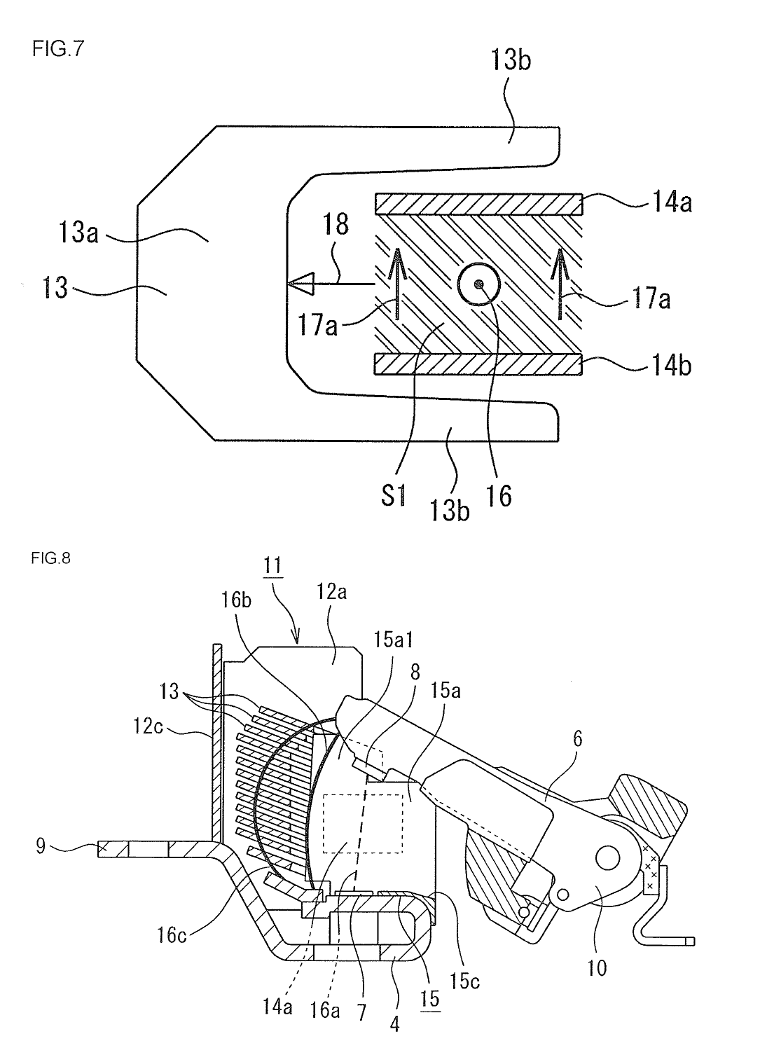

On the arc 16a generated between the fixed and the movable contact points 7 and 8, a magnetic flux 17a is generated in a space S1 between the pair of permanent magnets 14a and 14b disposed perpendicular to the arc 16a, and an electromagnetic force 18 acts on the arc 16a in accordance with Fleming's left hand rule, as shown in FIG. 7. Thereby, the arc 16a on which the electromagnetic force 18 has acted, moves to the back surface support plate 12c side of the arc extinguishing device (and is called an arc 16c), and the arc 16c contacts with the grids 13 of the arc extinguishing device 11 and is split up, cooled, and quickly extinguished. As a result, it is possible to improve the breaking performance of the circuit breaker 1, even when it is used in a high voltage direct current circuit.

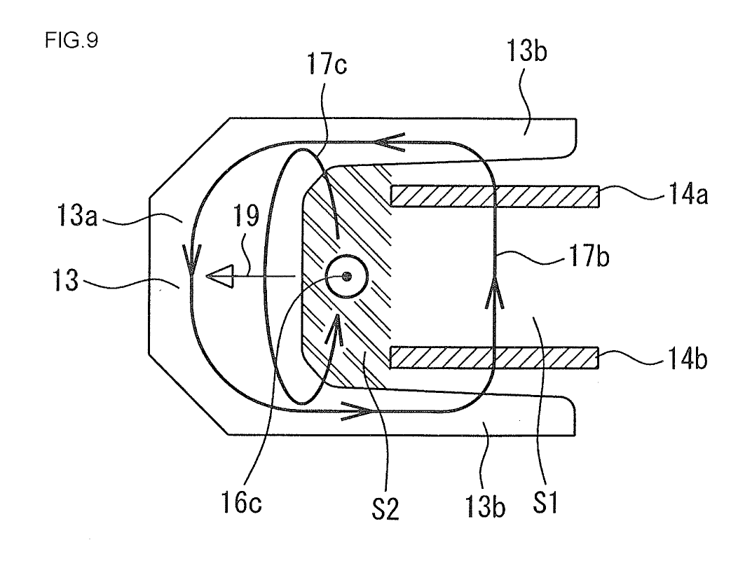

Also, as shown in FIG. 8 and FIG. 9, even when an arc 16b moves to a space S2 on the back surface support plate 12c side distanced from the space S1 between the pair of permanent magnets 14a and 14b, an electromagnetic force 19 acts on the arc 16b by a magnetic flux 17b generated from the pair of permanent magnets 14a and 14b to the pair of grid leg portions 13b and 13b of the grids 13 and to a magnetic flux 17c generated on the back surface support plate 12c side. Thereby, the arc 16b on which the electromagnetic force 19 has acted, immediately moves as the arc 16c on the back surface support plate 12c side of the arc extinguishing device 11, and it is possible to efficiently extinguish the arc 16c.

Also, as the grid leg portions 13b of the grids 13 are disposed on the outer side of a region in which the pair of permanent magnets 14a and 14b generates the magnetic flux 17, it is possible to prevent magnetic interference with the exterior caused by magnetic flux leakage from the permanent magnets 14a and 14b.

Also, the permanent magnet holding member 15 formed of a polymeric material emits a pyrolysis gas by thermal decomposition caused by the arc 16a generated between the fixed and the movable contact points 7 and 8, and the pyrolysis gas flows into the exterior from the gas exhaust openings 12c1 of the back surface support plate 12c. Thereby, as the flow of the pyrolysis gas causes the arc 16a to move in a direction such as to contact with the grids 13 of the arc extinguishing device 11, it is possible to accelerate the splitting up and cooling by contact with the grids 13.

Also, it may happen that the arc 16c is displaced to the leading end of the opened movable contact 6, as shown in FIG. 6, but as the permanent magnet holding member 15 of the embodiment is such that the dividing walls 15a1 and 15b1 formed on the upper surfaces of the pair of side surface insulating walls 15a and 15b, shield the arc 16c at the leading end of the movable contact 6 from the pairs of grid leg portions 13b of the grids 13, it is possible to prevent the arc 16c from being generated on the grids 13.

Also, the permanent magnet holding member 15 of the embodiment has a function of supporting the pair of permanent magnets 14a and 14b and, as the bottom surface insulating wall 15c linking the lower portions of the pair of side surface insulating walls 15a and 15b of the permanent magnet holding member 15 covers a position on the fixed contact 4 opposing the movable contact 6, as shown in FIG. 6, it is possible to prevent an arc (reference sign A indicated by a two-dot chain line in FIG. 6) from being generated between a middle portion of the movable contact 6 and the fixed contact 4.

Also, as the permanent magnet holding member 15 holds the pair of permanent magnets 14a and 14b, and the structure is such that the permanent magnet holding member 15 is disposed between the pairs of grid leg portions 13b and 13b of the plurality of grids 13 of the arc extinguishing device 11, it is sufficient to secure a space in the case 2 to dispose the arc extinguishing device 11; therefore, it is possible to provide a downsized circuit breaker 1.

Also, it is sufficient to use the arc extinguishing device 11 with the permanent magnet holding member 15 installed in a direct current circuit breaker, and to use the arc extinguishing device 11 with the permanent magnet holding member 15 removed as a part in an alternating current circuit breaker. Consequently, as circuit breakers for an alternating current circuit and direct current circuit both have the common assembly steps, it is possible to improve circuit breaker productivity.

### INDUSTRIAL APPLICABILITY

As heretofore described, the circuit breaker according to the invention has sufficient breaking performance in a high voltage direct current circuit, while achieving a reduction in device size, and as the circuit breaker has the same assembly steps as an alternating current circuit breaker, it is useful in improving productivity.

### REFERENCE SIGNS LIST

1 . . . Circuit breaker, 2 . . . Case, 3 . . . Cover, 4 . . . Fixed contact, 5 . . . Switching mechanism, 6 . . . Movable contact, 7 . . . Fixed contact point, 8 . . . Movable contact point, 9 . . . Power source side terminal, 10 . . . Movable contact holder, 11 . . . Arc extinguishing device, 12a, 12b . . . Side surface support plate, 12c . . . Back surface support plate, 12c1 . . . Gas exhaust opening, 13 . . . Grid, 13a . . . Grid base portion, 13b . . . Grid leg portion, 14a, 14b . . . Permanent magnet, 15 . . . Permanent magnet holding member, 15a, 15b . . . Side surface insulating wall, 15a1, 15b1 . . . Dividing wall, 15c . . . Bottom surface insulating wall, 15d, 15e . . . Flange portion, 15f, 15g . . . Permanent magnet engagement hole, 16a, 16b, 16c . . . Arc, 17a, 17b, 17c . . . Magnetic flux, 18, 19 . . . Electromagnetic force

1-5. (canceled)

6. A circuit breaker, comprising:
a fixed contact having a fixed contact point,
a movable contact having a movable contact point contacting with the fixed contact point,
an arc extinguishing device having permanent magnets and a permanent magnet holding member, and
a main body case housing the fixed contact, the movable contact and the arc extinguishing device,
wherein the arc extinguishing device includes a plurality of magnetic grids arranged in a layer form, each having a grid base portion formed in a U-shape or a V-shape and a pair of grid leg portions extending parallel to each other from the grid base portion, an arc generated between the fixed contact point and the movable contact point at a time of an opening operation, being drawn into the plurality of magnetic grids to extinguish,
the permanent magnet is arranged such that a magnetic flux is generated between the pairs of grid leg portions of the plurality of magnetic grids configuring the arc extinguishing device in a direction perpendicular to the arc generated between the fixed contact point and the movable contact point, and an electromagnetic force acts so that the arc moves to a grid base portion side, and
the permanent magnet holding member holds the permanent magnets and encloses a movement trajectory of the movable contact point.

7. The circuit breaker according to claim 6, wherein the permanent magnet holding member is arranged to be removed from between the pairs of grid leg portions of the plurality of magnetic grids.

8. The circuit breaker according to claim 6, wherein the permanent magnet holding member includes a pair of side surface insulating walls that is disposed parallel to and distanced from each other, and that enclose the movement trajectory of the movable contact point, and a bottom surface insulating wall that links bottom portions of the pair of side surface insulating walls; and
the pair of side surface insulating walls holds the permanent magnets, and the bottom surface insulating wall covers the fixed contact facing the movable contact other than the fixed contact point.

9. The circuit breaker according to claim 8, wherein the permanent magnet holding member further includes dividing walls that shield a leading end vicinity of the movable contact from the plurality of magnetic grids of the arc extinguishing device at a time of an opening operation, and protrude from upper portions of the pair of side surface insulating walls.

10. The circuit breaker according to claim 6, wherein the permanent magnet holding member is formed of a polymeric material that emits a pyrolysis gas caused by thermal decomposition.
